(19) United States
(12) Patent Application Publication
(10) Pub. No.: US 2020/0130378 A1
(43) Pub. Date: Apr. 30, 2020

(54) RECORDING APPARATUS AND RECORDING METHOD

(71) Applicant: Oki Data Corporation, Tokyo (JP)

(72) Inventor: Naoki KUROSAWA, Tokyo (JP)

(73) Assignee: Oki Data Corporation, Tokyo (JP)

(21) Appl. No.: 16/597,750

(22) Filed: Oct. 9, 2019

(30) Foreign Application Priority Data
Oct. 31, 2018 (JP) 2018-204624

(51) Int. Cl. B41J 11/00

(52) U.S. Cl. CPC B41J 11/002

(57) ABSTRACT

A recording apparatus according to an embodiment may include: a control unit that controls a medium conveyance unit to unwind the wound medium and convey the medium, a recording unit to record an image of recording agent on the medium, and a drying unit to dry the image of the recording agent in a first drying zone and a second drying zone downstream from the first drying zone. Upon causing the recording unit to record a second image after having caused the recording unit to record a first image, the control unit causes the drying unit to dry the recording agent of the first image in the first drying zone, and convey the medium in a direction opposite to the conveyance direction to a predetermined position downstream from the recording unit, and thereafter causes the recording unit to apply the recording agent of the second image to the medium.

### CROSS REFERENCE TO RELATED APPLICATIONS

This application claims priority based on 35 USC 119 from prior Japanese Patent Application No. 2018-204624 filed on Oct. 31, 2018, entitled “RECORDING APPARATUS AND RECORDING METHOD”, the entire contents of which are incorporated herein by reference.

### BACKGROUND

The disclosure relates to recording apparatuses and recording methods.

Inkjet printers, etc., are known, in which ink that is a recording agent is applied to a recording medium, such as paper, and the ink applied to the recording medium is dried. For example, Patent Document 1 (Japanese Patent No. 5578824) describes a print control apparatus in which an optimum print time can be selected according to print job, and a drying treatment can be cancelled or a drying time can be reduced according to a user's instruction.

### SUMMARY

However, in the related art, the next print job is not allowed until the selected drying time has passed. In addition, if a drying treatment is cancelled or a drying time is reduced according to a user's instruction, drying may be not adequately performed, resulting in a deterioration in recording quality.

An object of an aspect of one or more embodiments is to improve recording throughput without a deterioration in recording quality.

A first aspect of one or more embodiments may be a recording apparatus that may include: a medium conveyance unit that unwinds a medium wound in a roll and conveys the medium; a recording unit that records an image on the medium by applying a recording agent to the medium conveyed in a conveyance direction by the medium conveyance unit; a drying unit that dries the recording agent applied to the medium in a first drying zone located downstream from the recording unit in the conveyance direction, and in a second drying zone located downstream from the first drying zone in the conveyance direction; and a control unit that controls the medium conveyance unit, the recording unit, and the drying unit. Upon causing the recording unit to record a second image after having caused the recording unit to record a first image, the control unit causes the drying unit to dry, in the first drying zone, the recording agent of the first image applied to the medium, and causes, before drying the recording agent of the first image in the second drying zone, the medium conveyance unit to convey a portion of the medium in which the recording agent of the first image is applied, in a direction opposite to the conveyance direction, to a predetermined position located downstream from the recording unit in the conveyance direction, and thereafter, causes the recording unit to apply the recording agent of the second image to the medium.

A second aspect of one or more embodiments may be a recording method that may include: unwinding a medium wound in a roll and conveying the medium in a conveyance direction; recording an image on the medium by applying a recording agent to the medium at an application position; and drying the recording agent applied to the medium in a first drying zone located downstream from the application position in the conveyance direction, and in a second drying zone located downstream from the first drying zone in the conveyance direction. Upon recording a second image after a first image has been recorded, the recording agent of the first image is dried in the first drying zone, and before the recording agent of the first image is dried in the second drying zone, a portion of the medium in which the recording agent of the first image is conveyed in a direction opposite to the conveyance direction, to a predetermined position located downstream from the application position in the conveyance direction, and thereafter, the recording agent of the second image is applied to the medium.

According to at least one of the above aspects, recording throughput can be improved without a deterioration in recording quality.

### BRIEF DESCRIPTION OF DRAWINGS

FIG. 1 is a diagram illustrating a schematic view of a main configuration of an inkjet printer according to one or more embodiments.

FIG. 2 is a block diagram illustrating a schematic view of an overall configuration of an inkjet printer according to one or more embodiments.

FIGS. 3A and 3B are diagrams illustrating schematic views of examples of a hardware configuration of an inkjet printer according to one or more embodiments.

FIG. 4 is a diagram illustrating a schematic view for describing a conveyance path for a medium and a method of drying the medium according to one or more embodiments.

FIG. 5 is a flowchart illustrating an operation of an inkjet printer according to one or more embodiments.

FIG. 6 is a flowchart illustrating an operation of an inkjet printer in a successive printing process according to one or more embodiments.

FIG. 7 is a diagram illustrating a schematic view for describing a modification.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

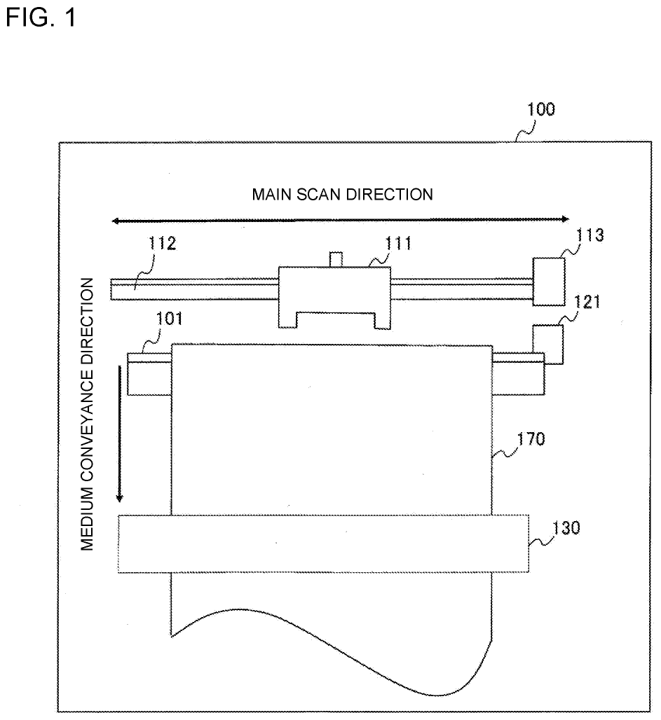

FIG. 1 is a diagram illustrating a schematic view of a main configuration of an inkjet printer 100 as a recording apparatus according to one or more embodiments. As illustrated in FIG. 1, the inkjet printer 100 includes a carriage 111, a carriage conveyance rail 112, a carriage motor 113, a platen 101, a medium conveyance roller 121, and an external dryer 130.

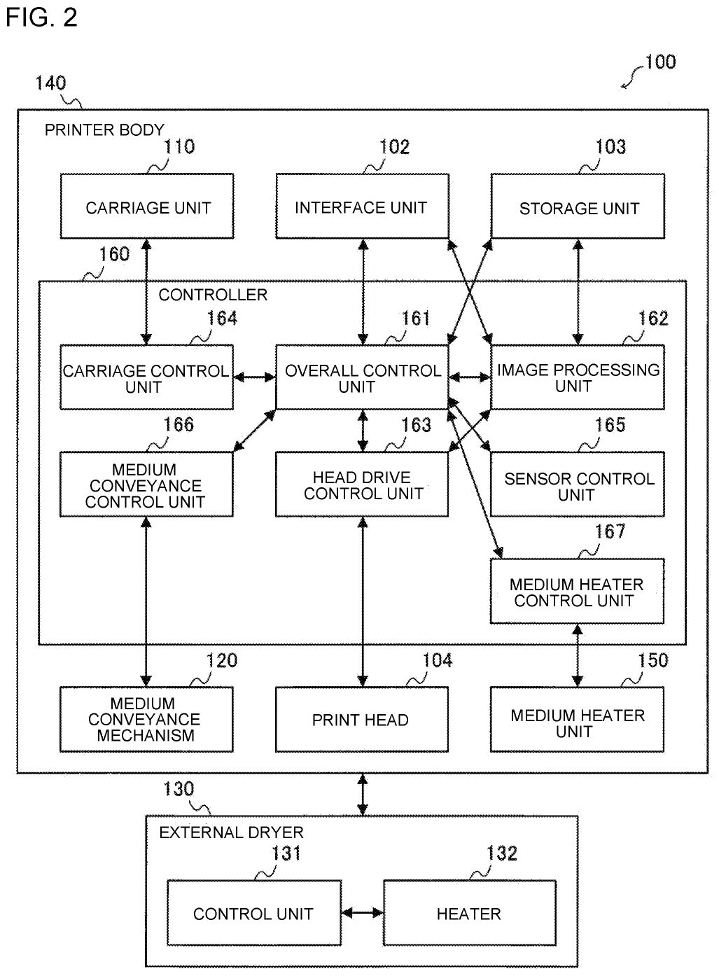

A print head 104 (see FIG. 2) that ejects ink which is a recording agent is mounted on the carriage 111, and reciprocates in a main scan direction to perform printing (recording). The carriage conveyance rail 112 guides movement of the carriage 111 in the main scan direction. The carriage motor 113 is for driving the carriage 111. Although not illustrated, the carriage 111 is enabled to perform reciprocating movement along the carriage conveyance rail 112 by driving a belt fixed to the carriage 111 using the carriage motor 113.

The medium conveyance roller 121 conveys a medium 170 on the platen 101. When printing is performed using the carriage 111, the medium conveyance roller 121 conveys the medium 170 in a medium conveyance direction.

It is assumed that the medium conveyance direction is a single predetermined direction in which the medium 170 is conveyed. For example, the medium conveyance direction intersects with the main scan direction in which the carriage 111 is moved, and is typically perpendicular to the main scan direction. The medium conveyance direction is also referred to as a sub-scan direction. An image is printed on the medium 170 by ejected ink being applied to the medium 170.

The external dryer 130 dries ink applied to the medium 170. The external dryer 130 includes, for example, a heater for drying ink. The external dryer 130 heats the medium 170 from the print side (front side) of the medium 170 on which an image is printed, without being in contact with the medium 170. Note that the external dryer 130 is desirably removable from a printer body 140.

FIG. 2 is a block diagram illustrating a schematic view of an overall configuration of the inkjet printer 100. As illustrated in FIG. 2, the inkjet printer 100 includes the external dryer 130 and the printer body 140.

The external dryer 130 includes a control unit 131 and a heater 132. The external dryer 130 is controlled from the printer body 140. The control unit 131 controls the overall operation of the external dryer 130. For example, the control unit 131 controls the heater 132 according to control from the printer body 140. The heater 132 dries ink applied to the medium 170 and forming an image. The heater 132 is operated and controlled by the control unit 131.

Each time an image has been printed on a portion of the medium 170, the medium 170 on which the image has been printed is conveyed. The printed portions are successively dried by the external dryer 130.

The printer body 140 includes an interface unit 102, a storage unit 103, a print head 104, a carriage unit 110, a medium conveyance mechanism 120, a medium heater unit 150, and a controller 160.

The interface unit 102 is an interface for communicating with a host personal computer (PC). In an embodiment, the interface unit 102 is implemented by a universal serial bus (USB) interface. The host PC is an information processing apparatus that transmits, to the inkjet printer 100, a print job which is a job for recording an image.

The storage unit 103 stores a program and data required for a process in the inkjet printer 100. For example, the storage unit 103 stores a print job acquired by the interface unit 102.

The print head 104 is a recording unit that applies ink to the medium 170 that is conveyed in the medium conveyance direction which is previously determined by the medium conveyance mechanism 120, and thereby records an image on the medium 170. For example, the print head 104 performs printing by ejecting ink according to a print job. Specifically, the print head 104 ejects ink to the medium 170 on the basis of data received from the controller 160.

The carriage unit 110, which includes the carriage 111, the carriage conveyance rail 112, and the carriage motor 113, which are illustrated in FIG. 1, is operated and controlled by the controller 160.

The medium conveyance mechanism 120, which includes the medium conveyance roller 121 illustrated in FIG. 1, is for conveying the medium 170 wound in a roll. The medium conveyance mechanism 120 includes, in addition to the medium conveyance roller 121, a rear guide 122, a front guide 123, a feed unit 124, a winding unit 125, and a tension roller 126, which are illustrated in FIG. 4. The medium conveyance mechanism 120 further includes a pinch roller and a conveyance motor, etc., which are not illustrated. The conveyance motor provides power to the various rollers, the feed unit 124, and the winding unit 125 included in the medium conveyance mechanism 120.

The medium heater unit 150 is a heat source for heating the medium 170. For example, the medium heater unit 150 includes medium heaters 151, 152, and 153, which are illustrated in FIG. 4.

The controller 160 controls a process in the inkjet printer 100. The controller 160 includes an overall control unit 161, an image processing unit 162, a head drive control unit 163, a carriage control unit 164, a sensor control unit 165, a medium conveyance control unit 166, and a medium heater control unit 167.

The overall control unit 161 manages the overall process in the inkjet printer 100. The image processing unit 162 reads out a print job stored in the storage unit 103, and converts the print job into drive data for driving the print head 104. Thereafter, the image processing unit 162 sends the drive data to the head drive control unit 163.

The head drive control unit 163 transfers, to the print head 104, the drive data received from the image processing unit 162. The carriage control unit 164 controls the operation of the carriage unit 110.

The sensor control unit 165 controls various sensors (not illustrated) provided at respective positions in the inkjet printer 100. The medium conveyance control unit 166 controls the medium conveyance mechanism 120. The medium heater control unit 167 controls the medium heater unit 150 in association with a print operation when an image is printed on the medium 170.

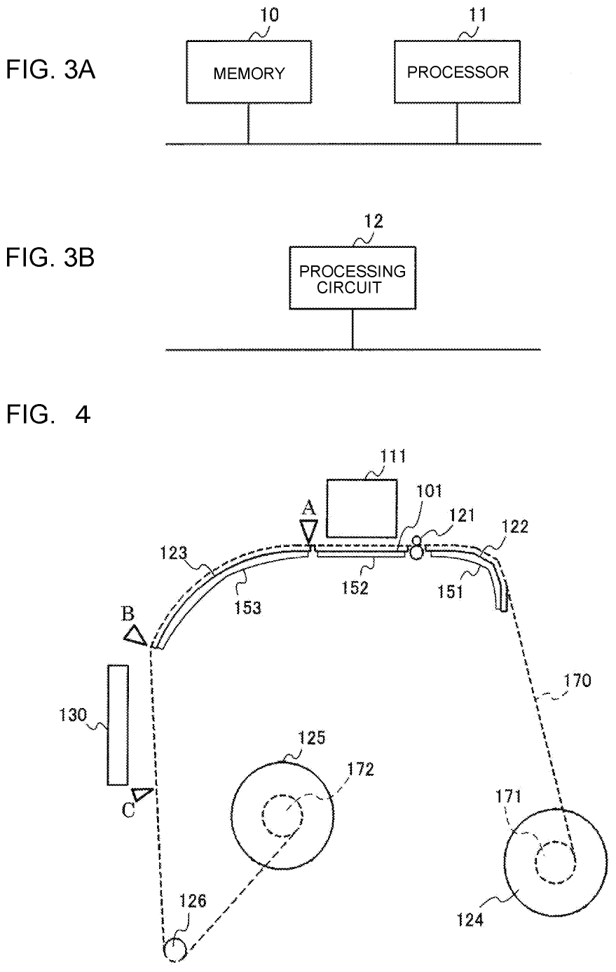

As illustrated in, for example, FIG. 3A, all or a portion of the controller 160 thus configured can be configured by a memory 10 and a processor 11 such as a central processing unit (CPU) that executes a program stored in the memory 10. Such a program may be provided through a network, or alternatively, may be recorded and provided in a storage medium. In other words, such a program may, for example, be provided as a program product.

In addition, as illustrated in, for example, FIG. 3B, a portion of the controller 160 can be configured by a processing circuit 12 such as a single circuit, composite circuit, programmed processor, parallel-programmed processor, application specific integrated circuit (ASIC), or field programmable gate array (FPGA).

Note that the storage unit 103 may be implemented by the memory 10, or may be implemented by other storage devices such as a read only memory (ROM), random access memory (RAM), or hard disk drive (HDD).

Next, a method of drying the medium 170 in the inkjet printer 100 is described with reference to FIG. 4. FIG. 4 is a schematic view for describing a conveyance path for the medium 170 and a method of drying the medium 170.

The medium 170 is wound into a roll around a feed reel 171 or a feed roll. The medium 170 wound around the feed reel 171 is conveyed along the rear guide 122 to the carriage 111 by the feed unit 124, the medium conveyance roller 121, and the winding unit 125.

The feed unit 124, which has a holder that holds the feed reel 171 around which the medium 170 is wound, drives the feed reel 171 to rotate using power received from a conveyance motor (not illustrated), and thereby feeds the medium 170. The winding unit 125, which has a holder that holds a winding reel 172 for winding the medium 170 on which an image has been recorded, drives the winding reel 172 to rotate using power received from a conveyance motor (not illustrated), and thereby winds the medium 170.

The rear guide 122 is heated by a medium heater 151 from the back side of the rear guide 122 that is an opposite side from the side that is brought into contact with the medium 170. The medium 170 is heated by the rear guide 122 while being conveyed along the rear guide 122, and is then fed between the platen 101 and the carriage 111.

The platen 101 is heated by a medium heater 152 from the back side thereof, i.e. an opposite side thereof from the carriage 111. The medium 170 conveyed to the platen 101 is also heated by the platen 101. By heating the medium 170 using the rear guide 122 and the platen 101, the temperature of the medium 170 is kept uniform, and therefore, the print quality can be maintained uniform.

The medium 170 conveyed onto the platen 101 is supported flat on the platen 101. The print head 104 mounted on the carriage 111 moving at a position facing the medium 170 on the platen 101 ejects ink onto the medium 170 to form dots, i.e. record an image. A position where the print head 104 ejects ink is where ink is applied.

The medium 170 on which an image has been recorded is conveyed onto the front guide 123. The front guide 123 is heated by a medium heater 153 from the back side thereof that is an opposite side from the side that is brought into contact with the medium 170. Therefore, the medium 170 being conveyed on the front guide 123, i.e. being in contact with the front guide 123, is also heated, so that drying of the ejected ink is accelerated, and therefore, fixation of the ink is accelerated. The heating of the medium 170 by the front guide 123 is performed from the back side of the medium 170 that is an opposite side from the side on which an image has been recorded. Note that the front guide 123 and the medium heater 153 function as a first drying unit that dries ink applied to the medium 170.

As described above, the medium 170 is heated by the rear guide 122 to an appropriate temperature (e.g., a suitable temperature between 30° C. and 60° C.), and an image is recorded on the medium 170 on the platen 101 with the medium 170 kept at an appropriate temperature (e.g., a suitable temperature between 30° C. and 60° C.). Thereafter, the medium 170 is heated on the front guide 123 to a predetermined temperature (e.g., a suitable temperature between 30° C. and 100° C.) for acceleration of drying and fixation.

The medium 170 after recording is wound around the winding reel 172 by the winding unit 125. The tension roller 126, which is provided along a width direction of the medium 170, is used to apply tension to the medium 170 hanging down from the front guide 123 so that the medium 170 does not become slack. When the medium 170 is tight, substantially all points on the medium 170 are at equal distances from the external dryer 130. As a result, specks caused by uneven drying can be prevented or reduced. The external dryer 130 heats the medium 170 in a non-contact manner, and therefore, the recording side of the medium 170 can be prevented from being damaged. Note that the external dryer 130 functions as a second drying unit that dries ink applied to the medium 170.

The drying of the medium 170 is performed in a first drying zone between a position A and a position B and in a second drying zone between the position B and a position C as illustrated in FIG. 4.

In the first drying zone, ink is fixed, and is dried to at least the extent that a printed image is not deformed. In the first drying zone, ink is dried by the front guide 123 heated by the medium heater 153. In order to prevent a deterioration in print quality, it is essential to perform drying in this zone.

Therefore, when a unit of image that is printed by performing a printing process (recording process) once using the print head 104 and the carriage unit 110 has been recorded, the image is always dried in the first drying zone. Here, in this embodiment, a unit that is printed by performing a printing process once is referred to as a job. Therefore, even in the case where there are two or more jobs, when one or more images included in a job have been recorded, the one or more images are dried in the first drying zone, and thereafter, the medium 170 is rewound by the medium conveyance mechanism 120, and one or more images included in the next job are recorded on the rewound medium 170.

The position A is where heating by the front guide 123 starts after recording on the platen 101. The position B is where heating by the front guide 123 ends. The medium 170 is heated from the back side thereof by the front guide 123 so that drying is accelerated. The heating by the front guide 123 can perform drying to the extent that the ink image is not deformed.

Here, the time it takes for the medium 170 to pass across the front guide 123 also varies depending on the print mode. Even when the medium 170 is printed in a fastest print mode, the medium 170 is dried to the extent that an image is not deformed while the medium 170 is being heated by the front guide 123. In a slow print mode, the heating time is longer, and therefore, the position B can be shifted toward the position A, depending on the drying time. Note that the position B is desirably where heating by the front guide 123 ends.

The position C is where drying by the external dryer 130 ends. If the heating temperature of the external dryer 130 is set to be higher than that of the front guide 123, and the medium 170 is heated from the recording side thereof by the external dryer 130, drying can be further accelerated. Therefore, the zone between the position B and the position C can be set to be shorter than the zone between the position A and the position B. As a result, the drying time of the external dryer 130 can be reduced.

The external dryer 130 performs heating at a temperature higher than the heating temperature of the front guide 123, and the heating by the external dryer 130 is performed in a non-contact manner. Accordingly, temperature variation on the medium 170 may occur. Therefore, in a case where drying is performed using the external dryer 130 immediately after an application position where the print head 104 on the carriage 111 ejects the ink onto the medium 170, image quality may be affected. Therefore, heating is preferably performed using the front guide 123 before the external dryer 130 is used. In such a configuration, heating can be performed by the front guide 123 and the external dryer 130 simultaneously when the medium has conveyed to some extent. Furthermore, the position B may be included in a region where drying is performed by the external dryer 130. In other words, in a final portion of the first drying zone, heating may be performed using the external dryer 130. Specifically, the heating by the front guide 123 is performed in at least a leading portion (upstream end portion in the medium conveyance direction) of the first drying zone, and the heating by the external dryer 130 is performed in at least a final portion (downstream end portion in the medium conveyance direction) of the second drying zone.

The second drying zone is for drying fixed ink, in which the ink is dried mainly by the external dryer 130. Here, in the second drying zone, the medium 170 is sufficiently dried to the extent that even when the medium is wound into a roll, layers of the medium 170 that is rolled after the printing do not stick together through ink. In other words, in the second drying zone, ink is dried to at least the extent that ink is not transferred between layers of the medium 170 that is rolled after the printing.

As described above, the first drying unit including the front guide 123 and the medium heater 153, and the second drying unit including the external dryer 130, together form a drying unit of the inkjet printer 100. In addition, the first drying zone is located downstream from the print head 104 in the medium conveyance direction, and the second drying zone is located downstream from the first drying zone in the medium conveyance direction.

Next, an operation of the inkjet printer 100 is described. Note that the operation is described, assuming that the inkjet printer 100 is coupled to the host PC through a USB cable, and the printer body 140 is coupled to the external dryer 130.

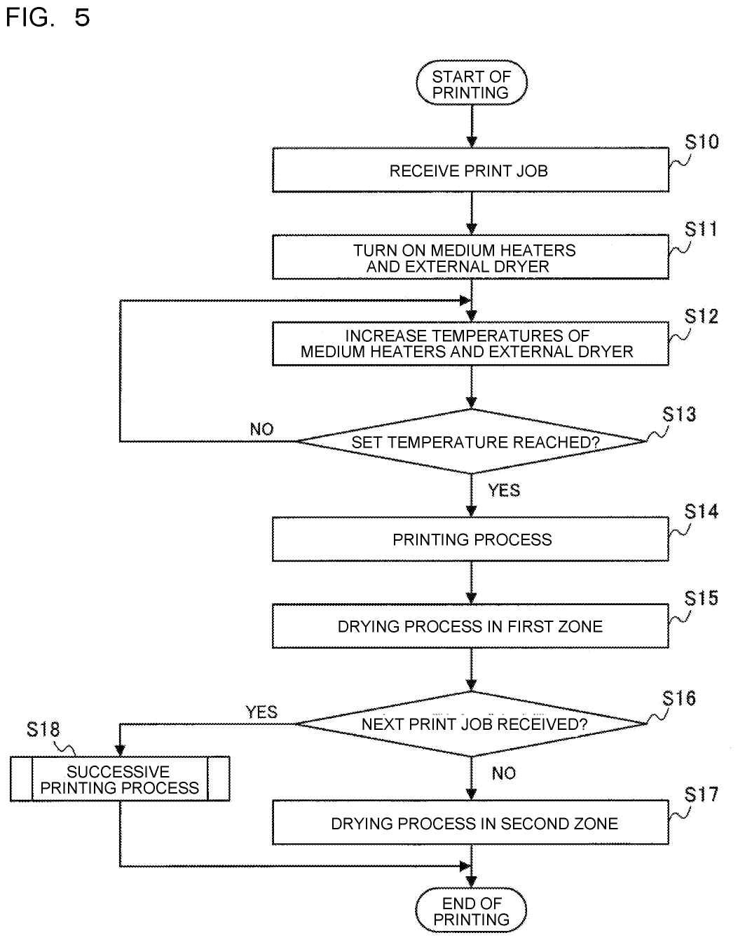

FIG. 5 is a flowchart illustrating an operation of the inkjet printer 100. The interface unit 102 of the inkjet printer 100 receives a print job from the host PC through the USB cable (S10). After receiving the print job, the interface unit 102 stores the received print job into the storage unit 103.

Next, the overall control unit 161 instructs the medium heater control unit 167 and the control unit 131 of the external dryer 130 to turn on the medium heaters 151, 152, and 153 and the heater 132 (S11). Note that the medium heaters 151, 152, and 153 and the heater 132 may each include heaters, which may be selectively turned on, depending on the type, width, or the like of the medium 170.

Thereafter, the overall control unit 161 instructs the medium heater control unit 167 and the control unit 131 of the external dryer 130 to increase the temperatures of the medium heaters 151, 152, and 153 and the heater 132 (S12).

Thereafter, based on, for example, the result of detection by sensors (not illustrated) from the sensor control unit 165, the overall control unit 161 determines whether or not the medium heaters 151, 152, and 153 and the heater 132 have reached respective predetermined temperatures (S13). If the predetermined temperatures have been reached (YES in S13), the process proceeds to step S14.

In step S14, the overall control unit 161 instructs the carriage control unit 164, the head drive control unit 163, and the medium conveyance control unit 166 to operate the carriage 111, eject ink, and convey the medium 170, respectively, so that a printing process is executed. At this time, the image processing unit 162 reads out a print job stored in the storage unit 103, converts the print job into drive data for driving the print head 104, and sends the drive data to the head drive control unit 163. After a printing process, drying is performed in the first drying zone to fix ink (S15).

Here, the printing in step S14 is performed by scanning in groups of a predetermined number of lines. For example, the medium conveyance mechanism 120 conveys the medium 170 by a predetermined distance in the medium conveyance direction, and thereafter, stops the medium 170. A process of causing the carriage 111 to move in the main scan direction and causing the print head 104 to eject ink is repeatedly performed, so that an image is completed. Even after the end of printing and completion of the image, the medium conveyance mechanism 120 conveys the medium 170 to the position B in a manner similar to that during printing. Specifically, the medium conveyance mechanism 120 intermittently conveys the medium 170 until the tail end of the completed image in the conveyance direction has reached at least the position B.

Thereafter, at the time that drying has been finished in the first drying zone, the overall control unit 161 determines whether or not the interface unit 102 has received the next print job (S16). If the next print job has not been received (NO in S16), the process proceeds to step S17. If the next print job has been received (YES in S16), the process proceeds to step S18.

In step S17, the external dryer 130 performs drying in the second drying zone. Also, in this case, the medium 170 is intermittently conveyed in a manner similar to that during printing until the tail end of the image recorded on the medium 170 in the conveyance direction has reached at least the position C. This is because the quality of the recorded image is affected if the conveyance conditions are changed.

Here, the control unit 131 controls an output to the heater 132 while measuring the temperature so that the heater 132 is maintained at a set temperature, for example, within the range of ±5° C. with respect to the set temperature. The external dryer 130 has a heating surface facing the print side. It is assumed that as the set temperature, a temperature is previously stored which is in the range of 30-200° C. and is suitable for an attribute of the medium 170 and a print mode (recording mode) such as a print speed, image quality, or ink amount. The medium 170 is conveyed at different speeds in different print modes, and therefore, the heating time is varied. The heating temperature and time are major factors in drying.

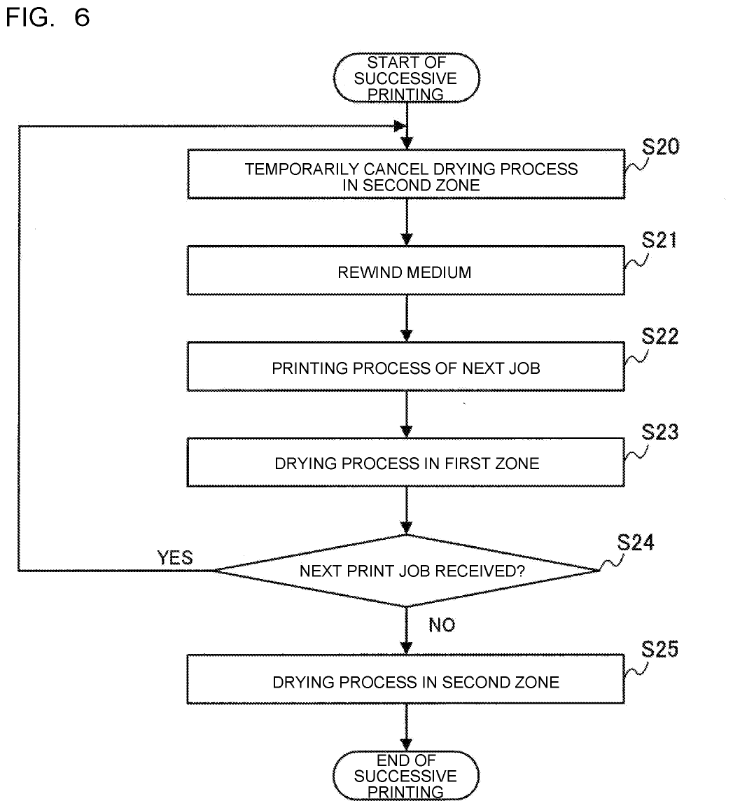

In step S18, the overall control unit 161 performs a successive printing process. The successive printing process is described in detail with reference to FIG. 6. In the case where images are recorded on the medium 170, a blank between images is a useless portion for the medium 170. Therefore, a large blank has a disadvantage in terms of cost. Therefore, it is desirable to reduce or eliminate a blank between images.

FIG. 6 is a flowchart illustrating an operation of the inkjet printer 100 in the successive printing process. The overall control unit 161 temporarily cancels drying in the second drying zone for a portion that has already been dried in the first drying zone (S20). The overall control unit 161 also instructs to the medium conveyance control unit 166 to rewind the medium 170 in the direction opposite to the medium conveyance direction. Here, the medium 170 is rewound to the extent that the tail end position in the medium conveyance direction of the image of a portion that has already been dried in the first drying zone reaches a predetermined next recording corresponding position (next print corresponding position). The next recording corresponding position may be determined, depending on how large a blank to be inserted between images is. In an embodiment, the next recording corresponding position is assumed to be the position A.

Thereafter, the overall control unit 161 instructs the carriage control unit 164, the head drive control unit 163, and the medium conveyance control unit 166 to operate the carriage 111, eject ink, and convey the medium 170, and executes a printing process of the next print job (S22).

After the printing process of the next print job, drying is performed in the first drying zone to fix the applied ink of the printing process (S23).

Next, at the time that the drying in the first drying zone has been finished, the overall control unit 161 determines whether or not the interface unit 102 has received the next print job (S24). If the next print job has not been received (NO in S24), the process proceeds to step S25. If the next print job has been received (YES in S24), the process returns to step S20.

In step S25, the external dryer 130 performs drying in the second drying zone.

Although not illustrated in the flowchart of FIG. 5 or 6, if the next print job has not been received in step S16 of FIG. 5 or step S24 of FIG. 6, and the print job has been received during the drying in the second drying zone of step S17 or S25, the overall control unit 161 may also cause the process to proceed to step S20 of FIG. 6. In this case, in step S20, drying is temporarily cancelled for the remaining portion of the second drying zone.

According to one or more embodiments as described above, in order to record a second image following a first image, the controller 160 causes the drying unit to dry applied ink of the first image in the first drying zone, and thereafter, before drying in the second drying zone, causes the medium conveyance mechanism 120 to convey the portion in which the applied ink of the first image to a predetermined position located downstream from the print head 104 in the medium conveyance direction, in the direction opposite to the medium conveyance direction, and thereafter, convey the medium in the medium conveyance direction, and causes the print head 104 to apply ink of the second image to the medium.

As a result, the drying in the first drying zone has been finished, and therefore, image quality is not substantially affected. Therefore, the medium 170 can be rewound, and printing can be performed with a blank reduced or eliminated. Therefore, the inkjet printer 100 can have improved print throughput with print quality maintained. In other words, even when the next print job has been received, drying is always performed in the first drying zone, and therefore, a deterioration in image quality can be prevented. In addition, in the case where print jobs are successively performed, a portion of drying in the previous print job is temporarily cancelled, and printing in the next print job is started, and therefore, throughput can be increased.

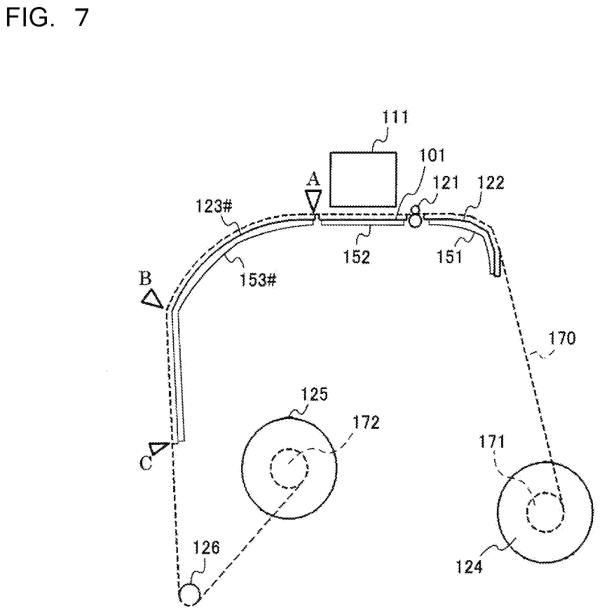

Although in the foregoing one or more embodiments, in the first drying zone, drying is performed by heating the medium 170 using the medium heater 153 and the front guide 123, the invention is not limited to such an example. For example, as illustrated in FIG. 7, a medium heater 153# and a front guide 123# may be extended to the position C, and perform drying in the second drying zone. In this case, the medium heater 153# and the front guide 123# together form a drying unit.

In addition, although in the foregoing one or more embodiments, an example has been illustrated in which the length of the first drying zone is fixed to the length between the position A and the position B, the length of the first drying zone may be changed, depending on at least the print mode (recording mode) or an attribute of the medium 170. In such a case, for example, the storage unit 103 may store correspondence information (table) indicating a correspondence between at least the print mode or an attribute of the medium 170, and the length of the first drying zone.

The invention includes other embodiments in addition to the above-described one or embodiments without departing from the spirit of the invention. The one or more embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A recording apparatus comprising:
a medium conveyance unit that unwinds a medium wound in a roll and conveys the medium;
a recording unit that records an image on the medium by applying a recording agent to the medium conveyed in a conveyance direction by the medium conveyance unit;
a drying unit that dries the recording agent applied to the medium in a first drying zone located downstream from the recording unit in the conveyance direction, and in a second drying zone located downstream from the first drying zone in the conveyance direction; and
a control unit that controls the medium conveyance unit, the recording unit, and the drying unit,
wherein
upon causing the recording unit to record a second image after having caused the recording unit to record a first image, the control unit causes the drying unit to dry, in the first drying zone, the recording agent of the first image applied to the medium, and causes, before drying the recording agent of the first image in the second drying zone, the medium conveyance unit to convey a portion of the medium in which the recording agent of the first image is applied, in a direction opposite to the conveyance direction, to a predetermined position located downstream from the recording unit in the conveyance direction, and thereafter, causes the recording unit to apply the recording agent of the second image to the medium.

2. The recording apparatus according to claim 1, wherein
the drying unit comprises a first drying unit and a second drying unit,
the first drying unit dries the recording agent in at least an upstream end portion of the first drying zone, and
the second drying unit dries the recording agent in at least a downstream end portion of the second drying zone.

3. The recording apparatus according to claim 2, wherein
the second drying unit is removable from the recording apparatus.

4. The recording apparatus according to claim 2, wherein
the first drying unit heats the medium from a back side of the medium, the back side being an opposite side from a front side of the medium to which the recording agent is applied, and
the second drying unit heats the medium from the front side of the medium.

5. The recording apparatus according to claim 4, wherein
the first drying unit heats the medium with the first drying unit in contact with a back surface of the medium, and
the second drying unit heats the medium without being in contact with a front surface of the medium.

6. The recording apparatus according to claim 4, wherein
a heating temperature of the second drying unit is higher than a heating temperature of the first drying unit.

7. The recording apparatus according to claim 6, wherein
the second drying zone is shorter than the first drying zone in the conveyance direction.

8. The recording apparatus according to claim 1, wherein
the drying unit heats the medium from a back side of the medium, the back side being an opposite side from a side of the medium to which the recording agent is applied.

9. The recording apparatus according to claim 8, wherein
the drying unit heats the medium with the drying unit in contact with a back surface of the medium.

10. The recording apparatus according to claim 1, wherein
in the first drying zone, the recording agent is dried to at least an extent that deformation of the image of the recording agent does not occur, and
in the second drying zone, the recording agent is dried to at least an extent that the recording agent is not transferred between layers of the medium when the medium is rolled.

11. The recording apparatus according to claim 1, wherein
a length of the first drying zone is changed, depending on at least one of a recording mode of the recording apparatus and an attribute of the medium.

12. A recording method comprising:
unwinding a medium wound in a roll and conveying the medium in a conveyance direction;
recording an image on the medium by applying a recording agent to the medium at an application position; and
drying the recording agent applied to the medium in a first drying zone located downstream from the application position in the conveyance direction, and in a second drying zone located downstream from the first drying zone in the conveyance direction, wherein
upon recording a second image after a first image has been recorded, the recording agent of the first image is dried in the first drying zone, and before the recording agent of the first image is dried in the second drying zone, a portion of the medium in which the recording agent of the first image is conveyed in a direction opposite to the conveyance direction, to a predetermined position located downstream from the application position in the conveyance direction, and thereafter, the recording agent of the second image is applied to the medium.

13. A recording method of recording an image on a medium being unwind from a roll and conveyed in a conveyance direction comprising:
recording, by a recording unit, a first image on the medium by applying a recording agent to the medium at an application position in the conveyance direction;
conveying, in the conveyance direction, a portion of the medium in which the recording agent of the first image is applied to the medium to a first drying zone located downstream from the application position in the conveyance direction,
drying, by a drying unit, the recording agent of the first image, in the first drying zone;
conveying the portion of the medium in which the recording agent of the first image is applied to the medium, in a direction opposite to the conveyance direction, to a predetermined position located downstream from the application position in the conveyance direction, instead of conveying the portion of the medium in which the recording agent of the first image is applied to the medium, in the conveyance direction, to a second drying zone located downstream from the first drying zone;
recording, by the recording unit, a second image on the medium by applying the recording agent to the medium at the application position;
conveying, in the conveyance direction, the portion of the medium in which the recording agent of the second image is applied to the medium to the first drying zone; and
drying, by the drying unit, the recording agent of the second image, in the first drying zone.
